(19) United States
(12) Patent Application Publication
(10) Pub. No.: US 2016/0063506 A1
(43) Pub. Date: Mar. 3, 2016

(54) CUSTOMER RELATIONSHIP MANAGEMENT (CRM) COMPUTER PROGRAM USER INTERFACE ADAPTATION BASED UPON SALES INTERACTION EVALUATION

(71) Applicant: SugarCRM Inc., Cupertino, CA (US)

(72) Inventors: Carl Edward Hicks, Santa Cruz, CA (US); Matthew Marum, Cary, NC (US)

(21) Appl. No.: 14/469,550

(22) Filed: Aug. 26, 2014

(51) Int. Cl. G06Q 30/00; G06Q 30/02

(52) U.S. Cl. CPC G06Q 30/01; G06Q 30/0201

(57) ABSTRACT

Embodiments of the invention include adapting a CRM user interface responsive to an analysis of CRM interactions data. In a method of the invention, different organizational representatives assign different qualitative values to correspondingly different interactions with one or more customers registered with the CRM system. Selected ones of the interactions are associated with resulting stages of a sales cycle for the corresponding customers and an elapsed time between the stages of the sales cycle is computed for the corresponding customers resulting from corresponding ones of the interactions. A particular stage of the sales cycle is selected for a particular customer and a specific interaction to be performed is determined based upon a computed fastest elapsed time for other customers at the particular stage. Finally, a user interface to the CRM system is updated to promote the specific interaction and to present the qualitative value assigned to the specific interaction.

### BACKGROUND OF THE INVENTION

1. Field of the Invention

The present invention relates to business opportunity management in a customer relationship management (CRM) computer program and more particularly to adapting controls in a user interface responsive to data within a CRM computer program.

2. Description of the Related Art

CRM refers to the interaction that a business entity enjoys with its customers, whether the business entity provides sales or services to the customer. CRM is often thought of as a business strategy that enables business managers to understand the customer, to retain customers through better customer experience, to attract new customers, increase profitability and to decrease customer management costs. In real terms, however, CRM systems are used specifically to manage business contacts, clients, contract wins and sales leads. As such, CRM solutions provide the end user with the customer business data necessary to provide services or products desired by the customers, to provide better customer service, to cross-sell and to up-sell more effectively, to close deals, retain current customers and understand the identity of the customer.

CRM systems are often used to manage the entire lifecycle of a relationship between a customer and an organization. In this regard, a CRM system is enabled to manage tasks for organizational representatives associated with the targeting and acquisition of a new customer, the fulfillment of a sale to a new customer or an existing customer, and the maintenance of a relationship with an existing customer. Much of the role of the CRM system is to store data documenting the relationship between representatives of an organization and its customers and prospective customers.

More particularly, CRM systems store troves of data pertaining to the human-to-human interactions between representatives of an organization and corresponding customers. This interactions data is leveraged in one of two ways. First, this interactions data is used to record the nature of the development of a relationship with a prospective customer. Second, this interactions data is used as a means to supervise the performance of the organizational representatives so as to gauge the progress of the organization in meetings its sales and support objectives. No other uses for the recorded interactions between organizational representatives and customers exist at present.

### BRIEF SUMMARY OF THE INVENTION

Embodiments of the present invention address deficiencies of the art in respect to CRM interaction data utilization and provide a novel and non-obvious method, system and computer program product for the adaptation of a CRM user interface responsive to an analysis of CRM interactions data. In an embodiment of the invention, a method for adapting a CRM user interface responsive to an analysis of CRM interactions data is provided. The method includes assigning by different organizational representatives in a CRM system executing in memory of a computer system, different qualitative values to correspondingly different interactions with one or more customers registered with the CRM system. The method further includes associating selected ones of the interactions with resulting stages of a sales cycle for the corresponding customers and computing an elapsed time between the stages of the sales cycle for the corresponding customers resulting from corresponding ones of the interactions. The method yet further includes selecting by a particular one of the organizational representatives, a particular stage of the sales cycle for a particular customer and determining a specific interaction to be performed by the particular one of the organizational representatives based upon a computed fastest elapsed time for other customers at the particular stage. Finally, the method includes updating a user interface to the CRM system to promote the specific interaction and to present the qualitative value assigned to the specific interaction.

In one aspect of the embodiment, the user interface to the CRM system is updated with a listing of interactions available to advance the particular customer to a next stage of the sales cycle from the selected particular stage of the sales cycle, the listing being sorted in an order from computed fastest elapsed time to a slowest elapsed time. In another aspect of the embodiment, the user interface to the CRM system is updated by removing from view any interactions assigned a negative qualitative value. In yet another aspect of the embodiment, the user interface to the CRM system is updated by removing from view any interactions having an elapsed time to a next stage that is greater than a threshold value. In even yet another aspect of the embodiment, the user interface to the CRM system is updated with a contextual dashlet suggesting the specific interaction.

In another embodiment of the invention, a CRM data processing system is configured for the adaptation of a CRM user interface responsive to an analysis of CRM interactions data. The system includes a host computing system that includes one or more computers each with memory and at least one processor. The system also includes a CRM system executing in the memory of the host computing system and providing end user access by different organizational representatives through respectively different user interfaces from over a computer communications network. The system additionally includes a data store of interactions coupled to the CRM system. The data store has records of different interactions with one or more customers registered with the CRM system. The records further include different qualitative values assigned to respectively different ones of the interactions by different ones of the organizational representatives. Even further, the records include different associations between the interactions and resulting stages of a sales cycle for corresponding ones of the customers. Finally, the records include different elapsed times between stages of the sales cycle for the corresponding customers resulting from corresponding ones of the interactions.

Of note, a user interface adaptation module is coupled to the CRM system and the data store. The module includes program code that when executed in the memory of the host computing system, responds to a selection by a particular one of the organizational representatives of a particular stage of the sales cycle for a particular customer by determining a specific interaction to be performed by the particular one of the organizational representatives based upon a computed fastest elapsed time for other customers at the particular stage and by updating a user interface to the CRM system to promote the specific interaction and to present the qualitative value assigned to the specific interaction.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for the adaptation of a CRM user interface responsive to an analysis of CRM interactions data;

FIG. 2 is a schematic illustration of a CRM data processing system configured for the adaptation of a CRM user interface responsive to an analysis of CRM interactions data; and,

FIG. 3 is a flow chart illustrating a process for the adaptation of a CRM user interface responsive to an analysis of CRM interactions data.

### DETAILED DESCRIPTION OF THE INVENTION

Embodiments of the invention provide for the adaptation of a CRM user interface responsive to an analysis of CRM interactions data. In accordance with an embodiment of the invention, each interaction between an organizational representative and a customer can be associated with a date of interaction, a qualitative value of efficacy and an associated stage of the sales cycle. In particular, the stage of the sales cycle can range from an initial or subsequent communication such as an e-mail message, to one or more interpersonal meetings, to the quotation of an offer for sale, the demonstration of a product or service, the closing of the sale, the fulfillment of the sale and the subsequent support of the utilization of the product or service by the customer.

Thereafter, the associations for each of the interactions can be analyzed to determine causal relationships between different interactions, an amount of time that has lapsed between different interactions, and a correlation between the different interactions and corresponding qualitative values assigned to the different interactions. The analysis subsequently can be applied to a particular stage of a sales cycle for a particular customer. Different potential interactions associated with the particular stage can be retrieved and an interaction that had previously been assigned a favorable qualitative score and that had resulted in advancement of the sales cycle to a next stage in a shortest period of time can be identified. Consequently, a user interface control can be re-arranged in a user interface of the CRM system to alert an organizational representative of the identified interaction. In this way, the organizational representative can be influenced to engage in a new interaction known to be most effective in advancing the sales cycle to the next stage.

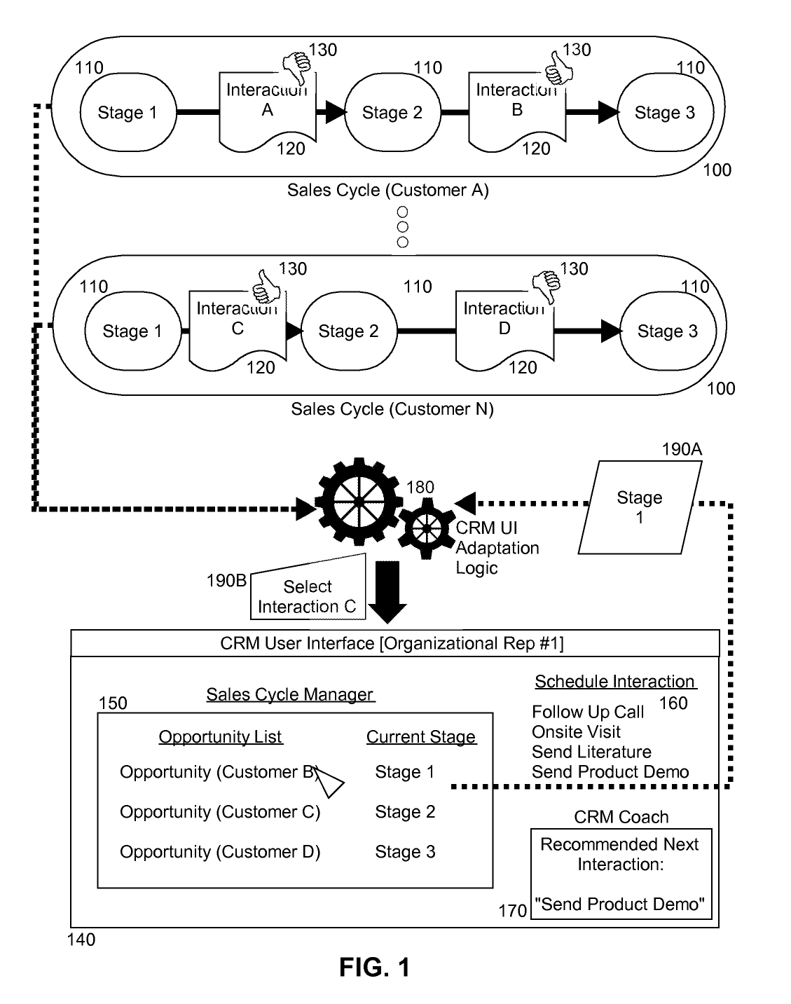

In further illustration, FIG. 1 pictorially shows a process for the adaptation of a CRM user interface responsive to an analysis of CRM interactions data. As shown in FIG. 1, the sales cycle 100 for different customers can be recorded to include a set of stages 110 of each sales cycle 100 and the interactions 120 occurring therebetween so as to cause a transition from one of the stages 110 to a next one of the stages 110. Each of the interactions 120 further can be assigned a qualitative value 130 indicating whether or not the organizational representative performing a corresponding one of the interactions 120 has subjectively viewed the corresponding one of the interactions 120 to have been positive in terms of causing the advancement of the sales cycle 100 to a next one of the stages 110. Of note, each of the interactions 120 can have associated therewith a date stamp. As such, an analysis of the date stamps of the interactions 120 can indicate an amount of time that has lapsed between an occurrence of a particular one of the interactions 120 for a corresponding one of the stages 110 and an occurrence of a next one of the stages 110 in the sales cycle 100.

A CRM user interface 140 can be provided for each organizational representative registered to utilize the CRM system. The CRM user interface 140 can include a listing of selectable business opportunities 150 for different customers whether potential or existing, and a related stage of the sales cycle for each of the business opportunities. The CRM user interface 140 also can include a listing of prospective interactions 160 able to be scheduled by the organizational representative for a selected one of the business opportunities. Finally, the CRM user interface 140 can include a CRM coach 170. The CRM coach 170 can be a user interface control displayable in the CRM user interface 170 and indicating a next recommended interaction to be performed by the organizational representative for the selected one of the business opportunities in the listing of selectable business opportunities 150.

In this regard, CRM user interface adaptation logic 180 can respond to a selection of one of the business opportunities in the listing of selectable business opportunities 150 by retrieving a corresponding contemporaneous stage 190A of the sales cycle for the selected one of the business opportunities. The CRM user interface adaptation logic 180 further can determine the interactions associated with the contemporaneous stage 190A and can compute an elapsed time for each of the determined interactions until a next stage of the sales cycle is reached. The CRM user interface adaptation logic 180 yet further can filter from the determined interactions those assigned a qualitative value below a threshold level. Finally, the CRM user interface adaptation logic 180 can select an unfiltered interaction 190B computed to have the shortest elapsed time. The CRM user interface adaptation logic 180 then can present the selected interaction 190B to the organizational representative in the CRM coach 170.

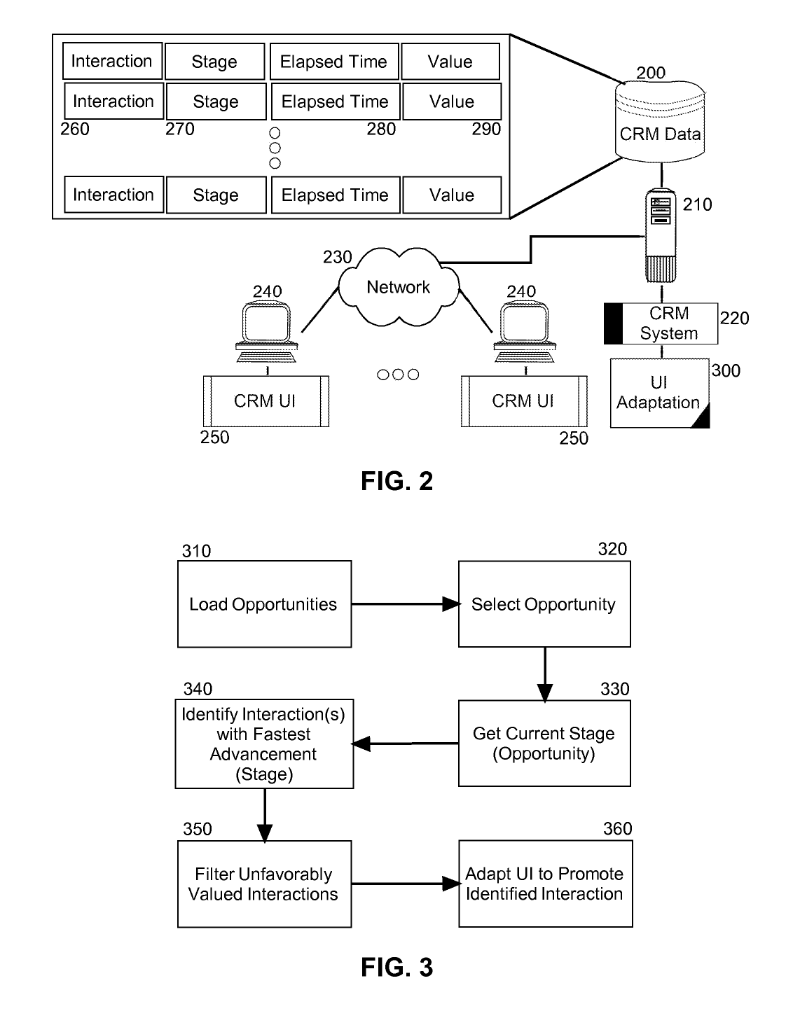

The process described in connection with FIG. 1 can be implemented in a CRM data processing system. In further illustration, FIG. 2 schematically shows a CRM data processing system configured for the adaptation of a CRM user interface responsive to an analysis of CRM interactions data. The system can include a host computing system 210 that includes one or more computers each with memory and at least one processor. The host computing system 210 can support the operation of a CRM system 220 utilizing CRM data in a data store 200 accessed by different end users from a CRM user interface 250 in a corresponding client computer 240 from over a computer communications network 230.

Of note, a CRM user interface adaptation module 300 can be coupled to the CRM system 220. The module 300 can include program code enabled upon execution in the memory of the host computing system 210 to process data in the CRM data store 200. Specifically, the program code of the module 300 can process records that include an interaction 260, a corresponding stage 270, a date stamp 280 and a qualitative value 290 for the interaction 260. Thereafter, in response to a selection through the CRM user interface 250 of a particular business opportunity at a particular stage, the program code of the module 300 can select from the records of the data store 200 an interaction 260 that in the past had resulted in an advancement of the sales cycle from the particular stage to a next stage in a fastest period of time while enjoying a favorable qualitative value assigned thereto. Finally, the program code of the module 300 can present the selected interaction in a dashlet of the CRM user interface 250.

In even yet further illustration of the operation of the CRM user interface adaptation logic 300, FIG. 3 is a flow chart illustrating a process for the adaptation of a CRM user interface responsive to an analysis of CRM interactions data. Beginning in block 310, a set of business opportunities can be loaded into memory, each opportunity having associated therewith a corresponding stage. In block 320, one of the opportunities can be selected in a CRM user interface and in block 330, a current stage of the selected one of the opportunities can be determined. In block 340, interactions associated with a fastest advancement to a next stage can be identified and in block 350, those of the identified interactions having a negative qualitative value can be filtered therefrom. Optionally, those of the interactions with an elapsed time that exceeds a threshold value can be filtered therefrom.

Finally, in block 360, the CRM user interface can be adapted to promote the remaining identified interactions. For example, the remaining interactions can be presented in a list and sorted in accordance with elapsed time for each of the interactions. Alternatively, a dashlet can be displayed in the CRM user interface suggesting one or more of the remaining interations.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for adapting a customer relationship management (CRM) user interface responsive to an analysis of CRM interactions data, the method comprising:
assigning by different organizational representatives in a CRM system executing in memory of a computer system, different qualitative values to correspondingly different interactions with one or more customers registered with the CRM system;
associating selected ones of the interactions with resulting stages of a sales cycle for the corresponding customers and computing an elapsed time between the stages of the sales cycle for the corresponding customers resulting from corresponding ones of the interactions;
selecting by a particular one of the organizational representatives, a particular stage of the sales cycle for a particular customer and determining a specific interaction to be performed by the particular one of the organizational representatives based upon a computed fastest elapsed time for other customers at the particular stage; and,
updating a user interface to the CRM system to promote the specific interaction and to present the qualitative value assigned to the specific interaction.

2. The method of claim 1, wherein the elapsed time for each stage of the sales cycle for a corresponding of the customers is computed by comparing in memory of the computing system a date when the corresponding one of the interactions occurred and a date when a next stage of the sales cycle for the corresponding one of the customers began.

3. The method of claim 1, wherein the user interface to the CRM system is updated with a listing of interactions available to advance the particular customer to a next stage of the sales cycle from the selected particular stage of the sales cycle, the listing being sorted in an order from computed fastest elapsed time to a slowest elapsed time.

4. The method of claim 1, wherein the user interface to the CRM system is updated by removing from view any interactions assigned a negative qualitative value.

5. The method of claim 1, wherein the user interface to the CRM system is updated by removing from view any interactions having an elapsed time to a next stage that is greater than a threshold value.

6. The method of claim 1, wherein the user interface to the CRM system is updated with a contextual dashlet suggesting the specific interaction.

7. A customer relationship management (CRM) data processing system configured for the adaptation of a CRM user interface responsive to an analysis of CRM interactions data, the system comprising:
a host computing system comprising one or more computers each with memory and at least one processor;
a CRM system executing in the memory of the host computing system and providing end user access by different organizational representatives through respectively different user interfaces from over a computer communications network;
a data store of interactions coupled to the CRM system, the data store comprising records of different interactions with one or more customers registered with the CRM system, the records further including different qualitative values assigned to respectively different ones of the interactions by different ones of the organizational representatives, the records yet further including different associations between the interactions and resulting stages of a sales cycle for corresponding ones of the customers, the records even yet further including different elapsed times between stages of the sales cycle for the corresponding customers resulting from corresponding ones of the interactions; and,
a user interface adaptation module coupled to the CRM system and the data store, the module comprising program code that when executed in the memory of the host computing system responds to a selection by a particular one of the organizational representatives of a particular stage of the sales cycle for a particular customer by determining a specific interaction to be performed by the particular one of the organizational representatives based upon a computed fastest elapsed time for other customers at the particular stage and by updating a user interface to the CRM system to promote the specific interaction and to present the qualitative value assigned to the specific interaction.

8. The system of claim 7, wherein the elapsed time for each stage of the sales cycle for a corresponding of the customers is computed by comparing in memory of the computing system a date when the corresponding one of the interactions occurred and a date when a next stage of the sales cycle for the corresponding one of the customers began.

9. The system of claim 7, wherein the user interface to the CRM system is updated with a listing of interactions available to advance the particular customer to a next stage of the sales cycle from the selected particular stage of the sales cycle, the listing being sorted in an order from computed fastest elapsed time to a slowest elapsed time.

10. The system of claim 7, wherein the user interface to the CRM system is updated by removing from view any interactions assigned a negative qualitative value.

11. The system of claim 7, wherein the user interface to the CRM system is updated by removing from view any interactions having an elapsed time to a next stage that is greater than a threshold value.

12. The system of claim 7, wherein the user interface to the CRM system is updated with a contextual dashlet suggesting the specific interaction.

13. A computer program product for adapting a customer relationship management (CRM) user interface responsive to an analysis of CRM interactions data, the computer program product comprising a computer readable storage medium having program instructions embodied therewith, the program instructions executable by a device to cause the device to perform a method comprising:
assigning, by the device, on behalf of different organizational representatives in a CRM system executing in memory of a computer system, different qualitative values to correspondingly different interactions with one or more customers registered with the CRM system;
associating, by the device, selected ones of the interactions with resulting stages of a sales cycle for the corresponding customers and computing an elapsed time between the stages of the sales cycle for the corresponding customers resulting from corresponding ones of the interactions;
selecting, by the device, on behalf of a particular one of the organizational representatives, a particular stage of the sales cycle for a particular customer and determining a specific interaction to be performed by the particular one of the organizational representatives based upon a computed fastest elapsed time for other customers at the particular stage; and,
updating, by the device, a user interface to the CRM system to promote the specific interaction and to present the qualitative value assigned to the specific interaction.

14. The computer program product of claim 13, wherein the elapsed time for each stage of the sales cycle for a corresponding of the customers is computed by comparing in memory of the computing system a date when the corresponding one of the interactions occurred and a date when a next stage of the sales cycle for the corresponding one of the customers began.

15. The computer program product of claim 13, wherein the user interface to the CRM system is updated with a listing of interactions available to advance the particular customer to a next stage of the sales cycle from the selected particular stage of the sales cycle, the listing being sorted in an order from computed fastest elapsed time to a slowest elapsed time.

16. The computer program product of claim 13, wherein the user interface to the CRM system is updated by removing from view any interactions assigned a negative qualitative value.

17. The computer program product of claim 13, wherein the user interface to the CRM system is updated by removing from view any interactions having an elapsed time to a next stage that is greater than a threshold value.

18. The computer program product of claim 13, wherein the user interface to the CRM system is updated with a contextual dashlet suggesting the specific interaction.
